(19) United States
(12) Patent Application Publication
(10) Pub. No.: US 2018/0088982 A1
(43) Pub. Date: Mar. 29, 2018

(54) PROVIDING HIGHLY AVAILABLE AND SCALABLE ACCESS TO A RESTRICTED ACCESS SERVICE THROUGH A RESTFUL INTERFACE

(71) Applicant: INTERNATIONAL BUSINESS MACHINES CORPORATION, Armonk, NY (US)

(72) Inventors: Robert M. Abrams, Wappingers Falls, NY (US); Victor G. Alonzo, Wappingers Falls, NY (US); Yuk L. Chan, Rochester, NY (US); Gisela C. Cheng, Rhinebeck, NY (US); Kin Ng, Wappingers Falls, NY (US); Vaughn C. Page, Wappingers Falls, NY (US)

(21) Appl. No.: 15/430,855

(22) Filed: Feb. 13, 2017

Related U.S. Application Data
(63) Continuation of application No. 15/274,059, filed on Sep. 23, 2016.

(51) Int. Cl. G06F 9/48

(52) U.S. Cl. CPC G06F 9/485

(57) ABSTRACT

Examples of techniques for invoking a restricted access service through a RESTful interface are disclosed. In one example implementation according to aspects of the present disclosure, a computer-implemented method may include: measuring, by the processing device, an idle time that represents an amount of time that an application is idle; measuring, by the processing device, an execution time that represents an amount of time that the application takes to execute a RESTful application program interface request; calculating, by the processing device, an average time for the application, wherein the average time is based on the idle time and the execution time over a selectable interval; and responsive to determining that the average time does not exceed a first threshold, initiating, by the processing device, a new instance of the application.

### DOMESTIC PRIORITY

This application is a continuation of U.S. patent application Ser. No. 15/274,059, entitled “PROVIDING HIGHLY AVAILABLE AND SCALABLE ACCESS TO A RESTRICTED ACCESS SERVICE THROUGH A RESTFUL INTERFACE,” filed Sep. 23, 2016, the disclosure of which is incorporated by reference herein in its entirety.

### BACKGROUND

The present techniques relate to a managing a processing system and, more particularly, for providing highly available and scalable access to a restricted access service through a representational state transfer (RESTful) interface.

Many installations today are looking to accelerate their business processes to allow immediate access to important applications and are looking to mobile applications as a key to achieving such assets. Mobile access improves the time it takes an information system professional (e.g., a system administrator, a system programmer, etc.) to obtain important information and make key decisions to maintain system availability. Often this can involve building a scalable and available mobile application that invokes native operating system function, available only using a programming interface that is not accessible to the web application that operates on behalf of a mobile application request.

### SUMMARY

According to examples of the present disclosure, techniques including methods, systems, and/or computer program products for providing highly available and scalable access to a restricted access service through a RESTful interface are provided. An example method may include: measuring, by the processing device, an idle time that represents an amount of time that an application is idle; measuring, by the processing device, an execution time that represents an amount of time that the application takes to execute a RESTful application program interface request; calculating, by the processing device, an average time for the application, wherein the average time is based on the idle time and the execution time over a selectable interval; and responsive to determining that the average time does not exceed a first threshold, initiating, by the processing device, a new instance of the application.

Additional features and advantages are realized through the techniques of the present disclosure. Other aspects are described in detail herein and are considered a part of the disclosure. For a better understanding of the present disclosure with the advantages and the features, refer to the following description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1 illustrates a block diagram of a processing system for a restricted access service through a RESTful interface according to examples of the present disclosure;

FIG. 2 illustrates a flow diagram of a method of a mobile application receiving diagnostic results from a RESTful API request as a JSON response according to aspects of the present disclosure;

FIG. 3 illustrates a flow diagram of a method for providing highly available and scalable access to a restricted access service through a RESTful interface according to aspects of the present disclosure;

FIG. 4 illustrates a block diagram of a processing system for implementing the techniques described herein according to examples of the present disclosure;

FIG. 5 illustrates a cloud computing environment according to examples of the present disclosure; and

FIG. 6 illustrates abstraction model layers according to examples of the present disclosure.

### DETAILED DESCRIPTION

In the present application, a “bridge” environment is created to invoke a restricted-access operating system programming interface, to invoke an operating system function that assesses the processing system for serious error symptoms and reports them back to the user of a mobile application. Various implementations are described below by referring to several examples an infrastructure that provides an information system professional (e.g., a system administrator, a system programmer, etc.) mobile access to z/OS® system by IBM® services required to do their jobs. Doing so enables installations to expose custom services and participate in an application program interface (API) economy to increase the value of their System z platform assets. In particular, the present disclosure describes the design of a mobile application that is scalable (i.e., able to handle multiple requests simultaneously) and available (i.e., application tasks that are always accessible to service requests) to invoke restricted access services, such as z/OS® runtime diagnostics.

The runtime diagnostics of z/OS® is a function that can be invoked with an operator command when the system is experiencing degradation or to check for potential problems. It examines the system as an experienced system operator would when a problem is occurring. Doing so saves significant time required to evaluate the system, determine what the next set of actions may be, and to identify to whom to assign the problem. A mobile application to invoke this system diagnostic function can be used by the information system professional remotely to check on system health or the information system professional may simply need to respond to a potential system problem from a mobile device (such as when not near a computer). However, to avoid delays when handling multiple users, the function is enabled to handle several requests simultaneously.

The present disclosure provides techniques to ensure that backend z/OS® applications serving RESTful API requests for restricted access z/OS® services provide a level of availability and scalability expected for z/OS® type services. This is accomplished by starting several instances of a z/OS® backend application. The z/OS® backend applications include built-in logic to self-manage a number of instances of the backend z/OS® application to ensure availability and scalability. Information system professionals may expect the same level and quality of service for the RESTful APIs that are being exposed as they currently receive from software-as-a-service (SaaS) APIs.

To support z/OS® restricted access services as a RESTful SaaS service, a pool of backend z/OS® applications is used to process the RESTful API requests and invoke the restricted access z/OS® services on behalf of the RESTful API caller. To ensure the level of service that z/OS® customers expect, the present techniques ensure that the service is reliably available and scalable. The present disclosure proposes techniques to achieve the needed availability and scalability for the z/OS® backend applications.

The web server supports more than one backend application registering as a server for a particular RESTful API. The web server routes RESTful API requests to the registered backend applications, such as in a round-robin fashion, based on server load, based on queue times, or the like.

Example embodiments of the disclosure include or yield various technical features, technical effects, and/or improvements to technology. Example embodiments of the disclosure provide a RESTful interface to enable a remote information system professional to perform system diagnostics on a system, such as a z/Architecture system from IBM®. Moreover, the present techniques provide highly available and scalable access to the restricted access service through the RESTful interface. These aspects of the disclosure constitute technical features that yield the technical effect identifying and solving system problems efficiently and effectively and of providing highly available and scalable access to provide improved processing system efficiency and reliability. As a result of these technical features and technical effects, invoking a restricted access service through a RESTful interface in accordance with example embodiments of the disclosure represents an improvement to existing techniques that information system professionals use to access and solve system problems. As another result of these technical features and technical effects, the access is highly available and scalable. It should be appreciated that the above examples of technical features, technical effects, and improvements to the technology of example embodiments of the disclosure are merely illustrative and not exhaustive.

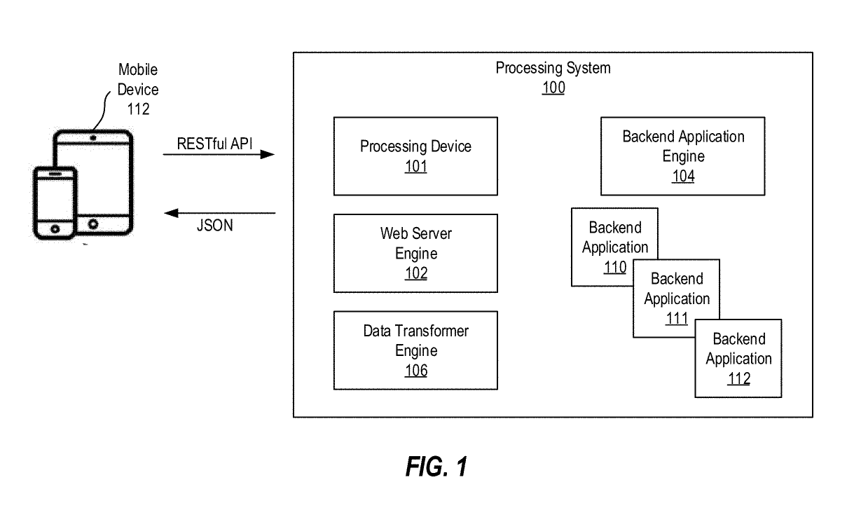

FIG. 1 illustrates a block diagram of a processing system 100 for providing highly available and scalable access to a restricted access service through a RESTful interface. The various components, modules, engines, etc. described regarding FIG. 1 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein may be a combination of hardware and programming. The programming may be processor executable instructions stored on a tangible memory, and the hardware may include a processing device 101 for executing those instructions. Thus a system memory can store program instructions that when executed by processing device 101 implement the engines described herein. Other engines may also be utilized to include other features and functionality described in other examples herein.

For a mobile application to interact with backend restricted access services on the processing system 100, a representational state transfer (RESTful) application program interface (API) may be used. A RESTful API is an API that uses HTTP requests to GET, PUT, POST, and DELETE data. Representational state transfer (REST), which is used by browsers, is a programming style for a client/server interface, similar to an HTTP request, with JavaScript object notation (JSON) output. In order to support invocation of z/OS® runtime diagnostics from a mobile device, a RESTful API is needed to invoke the internal z/OS® runtime diagnostic function. To do so, several requirements need to be satisfied: a target server to host the RESTful API function; the ability to securely invoke an internal restricted access z/OS® function; the ability; the ability to transform the output of an internal restricted access z/OS® function to a form that can be consumed by the RESTful API; and security for the RESTful API that is seamlessly integrated into the z/OS® security model.

Processing system 100 may include a processing device 101, a web server engine 102, a backend application engine 104, and a data transformer engine 106. Alternatively or additionally, the processing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

The web server engine 102 hosts RESTful APIs that are used to invoke the restricted access z/OS® services (i.e., backend applications 110, 111, 112). In particular, the web server engine 102 provides the following functionality: defining and hosting the RESTful APIs; providing a set of APIs that can be used by backend applications to register to receive and process requests from applications using the RESTful APIs; providing a security mechanism to authenticate and authorize callers to the hosted RESTful APIs; providing an infrastructure to associate a data transformer to a RESTful API so that any return data can be transformed to the proper JSON format with the correct character encoding (e.g., a complex extended binary coded decimal interchange code (EBCDIC) encoded output).

In one example, the web server engine 102 may be the IBM® WebSphere Liberty Profile (WLP) product with z/OS Connect. The WLP product provides a set of APIs (e.g., WebSphere optimized local adapters (WOLA)) that enable a back end application to register to a restricted access service specific RESTful APIs.

In some examples using WOLA according to aspects of the present disclosure, the web server engine 102 performs the following steps using a WOLA client: registering with WOLA; getting a data area (e.g., key 8); switching to a supervisor state; invoking a runtime diagnostics; switching to a problem state; passing output buffer (e.g., key 8) back to the web server engine 102. The WOLA client, in supervisor state, may perform the following runtime diagnostics, examining the system for anomalies related to: CPU usage, loop detection, enqueue contention, latch contention, F/S latch contention, server health, message analysis, job entry subsystem (JES2) health exceptions, etc.

The web server engine 102 supports more than one backend application (e.g., backend applications 110-112) registering as a server for a particular RESTful API. The web server routes RESTful API requests to the registered backend applications 110-112. The routing may be performed in various ways, such as in a round-robin fashion, based on server load, based on queue times, or the like. Generally, the processing flow is as follows: the web server engine 102 is called to register the web server 102 and the backend application 110-112 to service a particular RESTful API request; the web server engine 102 is called to wait for a RESTful request to arrive; when a RESTful API request is received, an environment is setup to call the restricted access service (e.g., backend applications 110-112); the application environment is changed to what the web server engine 102 needs and calls a web server API to return data to the web server; and the web server API is called to wait for another RESTful API request to arrive.

The backend application engine 104 invokes the restricted access z/OS® service. In particular, the backend application engine 104 provides the following functionality: running as a z/OS® batch application or started task; invoking the restricted access z/OS® services; invoking the web server APIs that enable the application to register to accept the RESTful API requests; and processing the RESTful API requests and returning data back to the web server engine 102.

The data transformer engine 106 transforms the EBCDIC encoded output from the restricted access z/OS® service to JSON format, such as with UTF-8 encoding. In particular, the data transformer engine 106 provides the following functionality: interpreting the structure of the output buffer from a restricted access z/OS® service; transforming EBCDIC encoded characters to UTF-8 encoded characters; transforming binary data to UTF-8 encoded data, and creating JSON format data from the transformed data.

As illustrated in FIG. 1, a mobile device 112 such as a smartphone, tablet computer, laptop computer, personal digital assistant, or other similar computing device, may be utilized by a user to access the processing system 100. In an example, the requests are transferred to the processing system via a RESTful API and results are returned in JSON.

To support a RESTful API, a set of backend applications (e.g., backend applications 110-112) is started (such as by a batch job or started task). In some examples, the backend applications 110-112 are designated as primary to ensure that they are running and are not terminated unless explicitly canceled (such as by an information system professional). This improves the availability of the application instances. The backend applications 110-112 contain z/OS® a recovery code to intercept problems in the function that they host and clear any offending (i.e., terminating) application instances (except when intentionally canceled). In the event one of the backend applications 110-112 terminates unexpectedly, the application engine 104 redeploys the application instance's process (e.g., a z/OS® started task). When a backend application is started, a parameter can be passed to the backend application to notify the backend application that it is designated as a primary backend application.

In examples, the backend applications 110-112 include logic to support various features. For example, a backend application may measure the time that the application is idle (i.e., waiting to receive a RESTful request). This can be measured by using the time from when the backend application last finished processing a request until the time that the application is woken up again to process a new request.

A backend application may also measure the time that the application takes to call a restricted access z/OS® service, such as z/OS® runtime diagnostics. This can be obtained by retrieving a first timestamp prior to calling the restricted access service and then retrieving a second timestamp when the restricted access service completes. The time duration difference between the first and second timestamps provides the time that the application takes to call the restricted access service.

A backend application may use the measured time to calculate a running total by adding the measured times. The running total can then be used to calculate an average by dividing the running total over a period, which can be any selectable or user-definable interval.

If the average time that an application is idle is below a first threshold, it can be inferred that the application is overly busy and more instances of the backend application can increase the performance of the processing system 100. In such a case, the application submits a job to start another instance of the backend application. For example, the backend application 110 submits a job to start a new instance of the backend application as backend application 111. There may exist a global configuration value that the backend applications can obtain to provide a limit on a number of instances of the backend application running at one time. For example, the number of instances may be limited to two instances, three instances, four instances, or some other suitable number.

If the average time that the backend application is idle is above a second threshold, it can be inferred that the application is not overly busy and may not be needed. In such a case, the backend application may be de-registered from the web server engine 102 and terminated. In some situations where a backend application is a “primary” application, it may not be terminated, except by a user. It should be appreciated that the first threshold may be greater than the second threshold.

For the restricted access services that return system data that does not change often but takes a long period of time to collect (as determined by the average time that the application was collecting the data), if the time that the data was previously collected has not passed a third threshold, it is assumed that the application instance may be hung. At that time, the cached copy of the data is returned instead of re-invoking the restricted access service. The possibly-hung application instance is then recovered (i.e., terminated and restarted) so that the application instance can be used for another request.

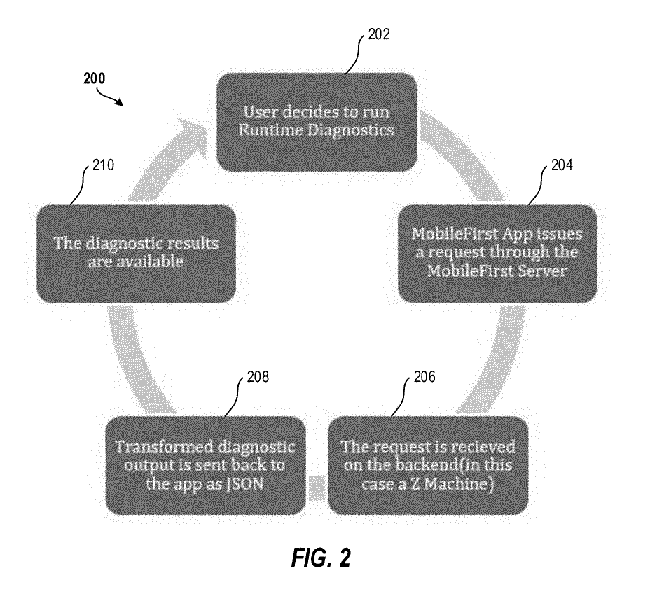

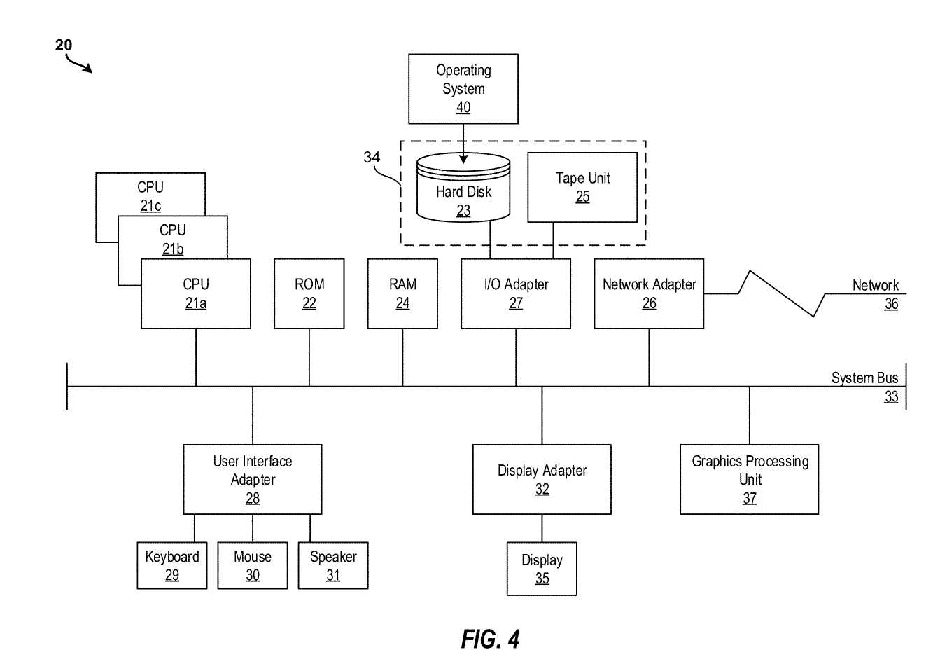

FIG. 2 illustrates a flow diagram of a method 200 of a mobile application receiving diagnostic results from a RESTful API request as a JSON response according to aspects of the present disclosure. The method 200 may be performed, for example, by a processing system such as the processing system 100 of FIG. 1, by the processing system 20 of FIG. 4, or by another suitable processing system.

At block 202, the method 200 includes beginning the runtime diagnostic process from a user's mobile application (e.g., the mobile device 112 of FIG. 1). At block 204, the method 200 includes issuing a request through a web server (e.g., the web server engine 102 of FIG. 1). At block 206, the request is received on a backend application (e.g., the backend application engine 104 of FIG. 1), which may be a z/OS® backend machine. At block 208, the method 200 includes transforming diagnostic data, such as by a data transformer (e.g., the data transformer 106 of FIG. 1), sent from the backend application back to the user's mobile device. At block 210, the diagnostic results are made available to the user on the user's mobile device.

Additional processes also may be included, and it should be understood that the processes depicted in FIG. 2 represent illustrations, and that other processes may be added or existing processes may be removed, modified, or rearranged without departing from the scope and spirit of the present disclosure.

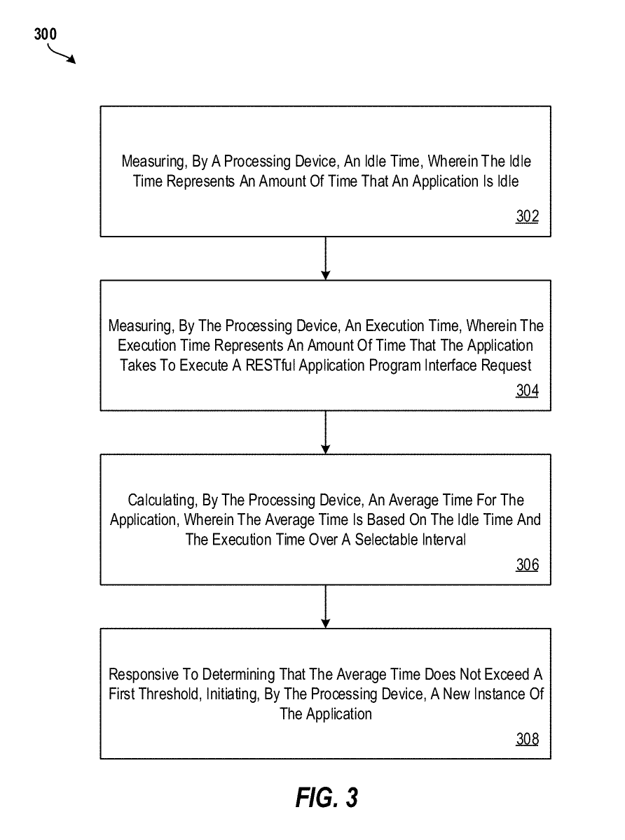

FIG. 3 illustrates a flow diagram of a method 300 for providing highly available and scalable access to a restricted access service through a restful interface. The method 300 may be performed, for example, by a processing system such as the processing system 100 of FIG. 1, by the processing system 20 of FIG. 4, or by another suitable processing system.

According to aspects of the present disclosure, at least one of the following preconditions may be met: web server (e.g., the web server engine 102 of FIG. 1) is been configured to host the RESTful API; the security infrastructure is configured such that authorized users and the users' associated passwords are stored into a security product (e.g., the resource access control facility (RACF) product by IBM®) that is used to restrict and authorize users' access to the RESTful API on the web server; a data transformer (e.g., the data transformer engine 106 of FIG. 1) that transforms the output returned from the restricted access z/OS® service is written and is configured to be associated with the RESTful API; a backend z/OS® application (e.g., the backend application engine 104) that calls the restricted access service is started as a batch job or a started task.

At block 302, the method 300 includes measuring an idle time, wherein the idle time represents an amount of time that an application is idle.

At block 304, the method 300 includes measuring an execution time, wherein the execution time represents an amount of time that the application takes to execute a RESTful application program interface request.

At block 306, the method 300 includes calculating an average time for the application, wherein the average time is based on the idle time and the execution time over a selectable interval.

At block 308, the method 300 includes responsive to determining that the average time does not exceed a first threshold, initiating a new instance of the application. In some examples, initiating the new instance of the application includes submitting a job to start the new instance of the application. In yet other examples, imitating the new instance of the application includes obtaining a global configuration value to ensure that the new instance of the application does not violate a maximum number of applications allowed.

Additional processes also may be included. For example, the method 300 may further include, responsive to determining that the average time exceeds a second threshold, alerting an information services professional that the application is idle. In another example, the method 300 may include, responsive to determining that the average time exceeds a threshold, de-registering the application from a web server and terminating the application. It should be understood that the processes depicted in FIG. 3 represent illustrations, and that other processes may be added or existing processes may be removed, modified, or rearranged without departing from the scope and spirit of the present disclosure.

In another embodiment, the backend applications 110-112 can be a persistent application that is always running and capable of running restricted access z/OS services, such as services that require specific user authorization or computer execution state. When a request is received at the web server engine 102, the request is associated with an account. An account number is used to track runtime information related to the processing of the request, including physical resource consumption such as processor cycles consumed, memory consumed; performance characteristics such as response time, queue time; and auditing information such as number of requests, time of each request. The association of a request with an account is based on some identification of the requester that initiated the request (e.g., an authenticated credential from the REST API, IP address of the requester, program name, etc.), category of the request (for example, database, system administration, serviceability, etc.), the specific z/OS service (e.g., a service to back up the storage system). The runtime information can further be used for reporting—audit tracking for the purpose of describing CPU resource used among the jobs and job types executing on the system; chargeback of costs based on usage, to business constituents for processing done on their behalf; and analytics—to identify the relationship of jobs and resource usage, for the purpose of determining trends.

In an example, the REST API service to invoke z/OS runtime diagnostics is called with a user credential. The web server engine 102 verifies if the user credential is authorized to invoke the specific service (z/OS Runtime Diagnostics). Then, the user credential is used to determine an account with which to be associated. This association is done using rules that the system administrator defined. The web server engine 102 selects one of the available backend application to process the z/OS runtime diagnostics request. After an available backend application is identified, the identifier of the backend application is associated with the account. The identifier could be the combination of a system name, address space identifier (ASID) and time (to thousandths of a second), or anything that uniquely identifier the backend application. Other examples include the combination of a job name, step name, time, program caller, job number and system name.

The backend application identifier is associated with the account, and a start-tracker for runtime information of the backend application is set. For example, the start-tracker can keep a record under the account for the physical processor that the backend application has used so far, and input/output read/write that the backend application has used so far. When the z/OS runtime diagnostics request completes, the backend application identifier is disassociated from the account, and an end-tracker for runtime information of the backend application is set. For example, the end-tracker can keep a record under the account for the physical processor that the backend application has used so far, and input/output read/write that the backend application has used so far. The difference between first tracker and second tracker is the physical processor and input/output read/write used by the request. A summary audit record with elapsed processor time and other calculated units is then recorded in a shared database, resident in the coupling facility connected to and shared with all other computer system images.

In another example, the REST API service to invoke a data deletion service is called with a user credential. The web server engine 102 verifies if the user credential is authorized to invoke the specific service (data deletion service). Then, the user requested the data deletion is associated with the backend application A1 performing the request at a time T1. When the backend application A1 deletes the data, the data deletion operation is audited under the identifier of the backend application at time T2. This auditing also includes whether the delete was successful, failed, failed reason, error, and error reason, for diagnostic purposes. In order to determine the user that is responsible for the data deletion, the auditing application scans the deleted data, and determines information related to the backend application that performed the deletion. This information includes the backend application identifier and T2. Then, based on the backend application identifier A1 and T2, user requested the deletion is determined by looking for a user invoked backend application with identifier A1 at T2.

In another example, the REST API service to invoke a data replication service is called with a departmental credential. The web server engine 102 verifies if the user credential is authorized to invoke the specific service (data replication service). Then, the department that requested the data replication is associated with the backend application A1 performing the request. Based on the departmental request, performance policy configuration is applied to the backend application. The performance policy configuration defines the number of processors available to the backend application, the response time of the request, the priority of the backend application in getting additional resources when there are other applications are also waiting for resources, and other related data. When the data replication request is completed, the backend application A1 is dissociated from the departmental credential, and managed under a different performance policy configuration.

In another example, the REST API service to invoke a detachment of storage device is called with a procedural id and credential. The web server engine 102 verifies if the procedural id and credential is authorized to invoke the specific service (detachment of storage device). Then, the procedural id associated with the request makes available to the backend application A1 performing the request. The procedural id and credential is made available through a shared memory between the web server engine 102 (or, WOLA within it) and the backend application A1. The procedural id can pass into the storage controller of the storage device for auditing and further security verification.

It is understood in advance that the present disclosure is capable of being implemented in conjunction with any other type of computing environment now known or later developed. For example, FIG. 4 illustrates a block diagram of a processing system 20 for implementing the techniques described herein. In examples, processing system 20 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 26 interconnects system bus 33 with an outside network 36 enabling processing system 20 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system such as the AIX® operating system from IBM Corporation to coordinate the functions of the various components shown in processing system 20.

In other examples, the present disclosure may be implemented on cloud computing. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

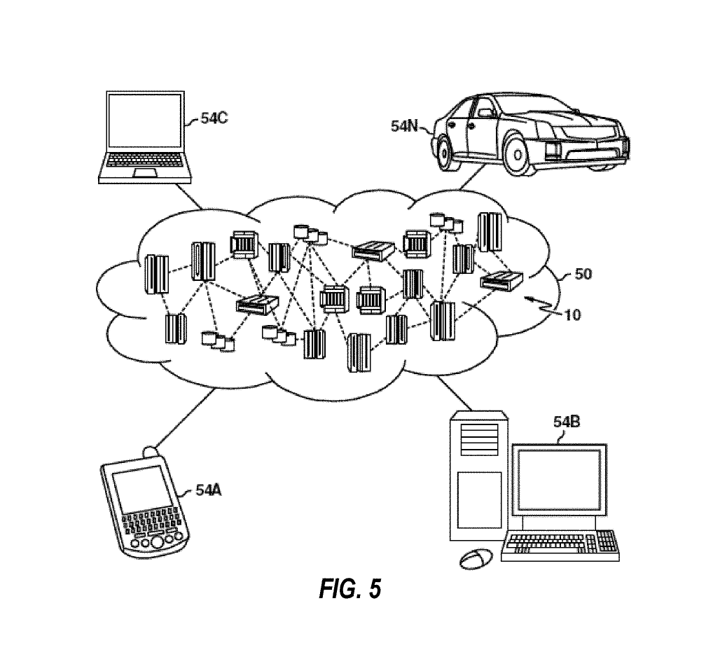

Referring now to FIG. 5, illustrative cloud computing environment 50 is illustrated. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

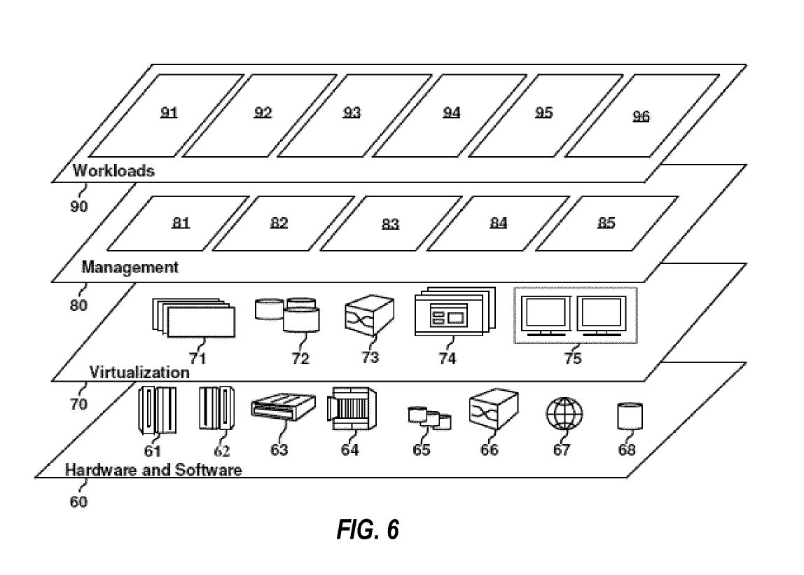

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As illustrated, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and invoking an authorized service through a RESTful API 96.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

What is claimed is:

1. A computer-implemented method for providing highly available and scalable access to a restricted access service through a representational state transfer (RESTful) interface, the method comprising:
measuring, by a processing device, an idle time that represents an amount of time that an application is idle;
measuring, by the processing device, an execution time that represents an amount of time that the application takes to execute a RESTful application program interface request;
calculating, by the processing device, an average time for the application, wherein the average time is based on the idle time and the execution time over a selectable interval; and
responsive to determining that the average time does not exceed a first threshold, initiating, by the processing device, a new instance of the application.

2. The method of claim 1, further comprising, responsive to determining that the average time exceeds a second threshold, alerting, by the processing device, an information services professional that the application is idle.

3. The method of claim 2, wherein the first threshold is greater than the second threshold.

4. The method of claim 1, further comprising, responsive to determining that the average time exceeds a second threshold, de-registering, by the processing device, the application from a web server and terminating, by the processing device, the application.

5. The method of claim 4, wherein the first threshold is greater than the second threshold.

6. The method of claim 4, wherein the application is not terminated when the application is designated as a primary application.

7. The method of claim 4, further comprising redeploying the application when it is determined that the application terminates unexpectedly.

8. The method of claim 1, wherein initiating the new instance of the application comprises submitting a job to start the new instance of the application.

9. The method of claim 1, wherein initiating the new instance of the application comprises obtaining a global configuration value to ensure that the new instance of the application does not violate a maximum number of applications allowed.
